(19) United States
(12) Patent Application Publication
(10) Pub. No.: US 2015/0240814 A1
(43) Pub. Date: Aug. 27, 2015

(54) COMPRESSOR FOR NATURAL GAS

(71) Applicant: Tecumseh Products Company, Ann Arbor, MI (US)

(72) Inventors: Roger D. Snyder, Jasper, MI (US); Anthony S. Carstensen, Tecumseh, MI (US); Joseph M. LaRocca, Eastpointe, MI (US); Robert L. Terry, Tecumseh, MI (US)

(21) Appl. No.: 14/590,285

(22) Filed: Jan. 6, 2015

Related U.S. Application Data
(60) Provisional application No. 61/942,685, filed on Feb. 21, 2014.

(51) Int. Cl. F04C 18/34; F17C 5/06; F04C 29/00; F04C 28/08; F04C 29/04

(52) U.S. Cl. CPC F04C 18/34; F04C 28/08; F04C 29/045; F04C 29/0085; F17C 5/06; F17C 2221/033; F17C 2227/0164

(57) ABSTRACT

A compact compressor is provided which can be used for production of very high-pressure end products using a multi-stage compression process. In one exemplary application, the compressor can be used for each stage of the multi-stage compression process used in production of compressed natural gas (CNG), in which low-pressure natural gas (NG) is compressed to less than 1 percent of its volume at standard atmospheric pressure (e.g., to 2,900-3,600 psi or 20-25 MPa). The compressor includes spark-avoidance, heat-mitigation and oil separation systems to safely and effectively produce CNG from NG.

### CROSS-REFERENCE TO RELATED APPLICATION

This application claims the benefit under 35 U.S.C. §119(e) of U.S. Provisional Patent Application Ser. No. 61/942,685 filed Feb. 21, 2014, entitled COMPRESSOR FOR NATURAL GAS, the entire disclosure of which is hereby expressly incorporated herein by reference.

### TECHNICAL FIELD

The present disclosure relates to hermetically sealed compressors and, more particularly, to rotary compressors adapted for use with natural gas as a working fluid.

### BACKGROUND

Compressed natural gas (CNG) is a gas primarily composed of methane (CH₄) together with smaller amounts of higher alkanes and other chemical substances, and is typically stored at high pressure. CNG is gaining increasing acceptance as an alternative to gasoline, diesel fuel and propane for use in vehicles, generators and household appliances, for example. CNG combustion produces fewer undesirable gases than many other fuels, and is also considered safer than other fuels in the event of a spill because natural gas is lighter than air and disperses quickly when released from containment.

CNG is made by compressing natural gas (NG), which may be found above oil deposits, or in landfills or wastewater treatment plants where it is sometimes known as biogas. Most commonly, NG is transported from production sites (which are frequently far from storage facilities and export terminals) by a distribution pipeline, usually at “low” pressure (e.g., <15 psi or 0.1 MPa) or “medium” pressure (e.g., 15-100 psi or 0.1-0.7 MPa). These distribution pipelines terminate at an intermediate distribution facility such as a fueling station, export terminal or storage facility, where the NG is made into CNG by compressing the NG to a higher pressure and resulting smaller volume. This reduced volume facilitates transport to end users, or use in vehicles.

Compression of NG to CNG may be performed using a “cascade” storage system in which a single, large multi-stage compressor is used to repeatedly compress the NG to successively higher pressures until a final, high-pressure state is achieved. Typically, this single large compressor is approximately the size of a 55-gallon (208-liter) drum, having a height of about 30 or more inches (76.2 or more centimeters) and a diameter of about 20 or more inches (50.8 or more centimeters). The compressor includes a reciprocating compression mechanism that is large in size, which in turn dictates a large overall size for the compressor itself.

Alternatively, a series of compressors may be used, wherein a separate compressor may be used to compress the NG to each successively higher-pressure stage, with each compressor successively more powerful to handle the successively higher pressures.

The final pressure of CNG may be maintained in a storage vessel at a pressure higher than that in a vehicle's on-board fuel tank, so that gas flows from the storage vessel to the fuel tank under differential pressure. Typically, the multi-stage storage operation will achieve a final pressure of about 3,600 psi (24.8 MPa), while a vehicle's maximum onboard storage pressure may be marginally lower at 2,900 psi (20 MPa). CNG may be dispensed to onboard storage of natural gas-powered vehicles, or to storage containers for transport to remote locations.

### SUMMARY

The present disclosure provides a compact compressor which can be used for production of very high-pressure end products using a multi-stage compression process. In one exemplary application, the compressor can be used for each stage of the multi-stage compression process used in production of compressed natural gas (CNG), in which low-pressure natural gas (NG) is compressed to less than 1 percent of its volume at standard atmospheric pressure (e.g., to 20-25 MPa or 2,900-3,600 psi). The compressor includes spark-avoidance, heat-mitigation and oil separation systems to safely and effectively produce CNG from NG.

In one form thereof, the present disclosure provides a natural gas compressor, including a housing having an inlet and an outlet, the housing including a unitary base structure and a pair of end caps fixed to the base structure, the housing able to contain a pressure of 3,600 psi (24.8 MPa); the housing enclosing an internal cavity defining an internal volume between about 196 cubic inches (3,218 cubic centimeters) and about 2,389 cubic inches (39,152 cubic centimeters); a rotary compressor mechanism disposed within the housing and having an electric motor, the rotary compressor mechanism operable to receive low-pressure natural gas at the inlet, compress the low-pressure natural gas to high-pressure compressed natural gas within the housing, and discharge the high-pressure natural gas at the outlet; and a control system operably connected to the motor and comprising at least one of a temperature sensor mounted to the motor and a current sensor positioned to measure electrical current supplied to the motor, the control system configured to deactivate the motor when a predetermined compressor state is detected, the predetermined compressor state comprising at least one of a temperature above a temperature threshold as measured by the temperature sensor and a current above a current threshold as measured by the current sensor.

In another form thereof, the present disclosure provides a natural gas compressor, including a housing comprising: a unitary base structure made of steel and defining a minimum material thickness of one inch (2.5 centimeters); a top end cap made of steel and defining a minimum material thickness of one inch (2.5 centimeters), the top end cap sealingly attached to a first open end of the unitary base structure; a bottom end cap made of steel and defining a minimum material thickness of one inch (2.5 centimeters), the bottom end cap sealingly attached to a second open end of the unitary base structure such that the unitary base structure, the top end cap and the bottom end cap define a hermetically sealed cavity having an inlet and an outlet; the housing defining an overall diameter between 7 inches (17.8 centimeters) and 15 inches (38.1 centimeters) and a height between 12 inches (30.5 centimeters) and 20 inches (50.8 centimeters); a compressor mechanism disposed within the housing and including a compressor motor, the compressor mechanism operable to receive low-pressure natural gas at the inlet, compress the low-pressure natural gas to high-pressure compressed natural gas within the housing, and discharge the high-pressure natural gas at the outlet; and a control system operably connected to the compressor mechanism and comprising at least one of a temperature sensor mounted to the motor and a current sensor positioned to measure electrical current supplied to the motor, the control system configured to deactivate the motor when a predetermined compressor state is detected, the predetermined compressor state comprising at least one of a temperature above a temperature threshold as measured by the temperature sensor and a current above a current threshold as measured by the current sensor.

In yet another form thereof, the present disclosure provides a multistage natural gas compression system, including a natural gas supply; a plurality of storage tanks adapted to receive and store the natural gas at an elevated pressure, the plurality of storage tanks including an upstream tank having a first pressure and a downstream tank having a second pressure higher than the first pressure; a compact natural gas compressor, including a hermetically sealed housing having a fluid inlet and a fluid outlet, the fluid inlet in selective fluid communication with the natural gas supply and at least one of the plurality of storage tanks, the fluid outlet in selective fluid communication with each of the plurality of storage tanks, the housing enclosing an internal cavity defining an internal volume between about 196 cubic inches (3,218 cubic centimeters) and about 2,389 cubic inches (39,152 cubic centimeters); and a compressor mechanism including a motor disposed within the housing between the fluid inlet and the fluid outlet, a valving arrangement operably coupled to the compressor, the plurality of storage tanks and the natural gas supply, the valving arrangement having a first-stage configuration in which the compressor mechanism receives natural gas from the natural gas supply via the inlet, compresses the natural gas, and transmits the natural gas via the fluid outlet to the upstream tank, the valving arrangement having a second-stage configuration in which the compressor mechanism receives natural gas from the upstream tank, further compresses the natural gas, and transmits the natural gas via the fluid outlet to the downstream tank.

### BRIEF DESCRIPTION OF THE DRAWINGS

The above-mentioned and other features and advantages of this disclosure, and the manner of attaining them, will become more apparent and the invention itself will be better understood by reference to the following description of an embodiment of the invention taken in conjunction with the accompanying drawings, wherein:

FIG. 1 is a side elevation, cross-sectional view of a compressor made in accordance with the present disclosure;

FIG. 2 is an exploded perspective view of a portion of the compressor shown in FIG. 1;

FIG. 3 is a plan, cross-sectional view of the compressor mechanism of the compressor of FIG. 1, taken along line of FIG. 1;

FIG. 4 is an exploded view showing components of the shell of the compressor of FIG. 1;

FIG. 5 is a fragmentary cross-sectional view of an upper portion of the compressor of FIG. 1; and

FIG. 6 is a schematic view of a vehicle-fueling application for the compressor of FIG. 1.

Corresponding reference characters indicate corresponding parts throughout the several views. The exemplification set out herein illustrates an exemplary embodiment of the invention and such exemplification is not to be construed as limiting the scope of the invention in any manner.

### DETAILED DESCRIPTION

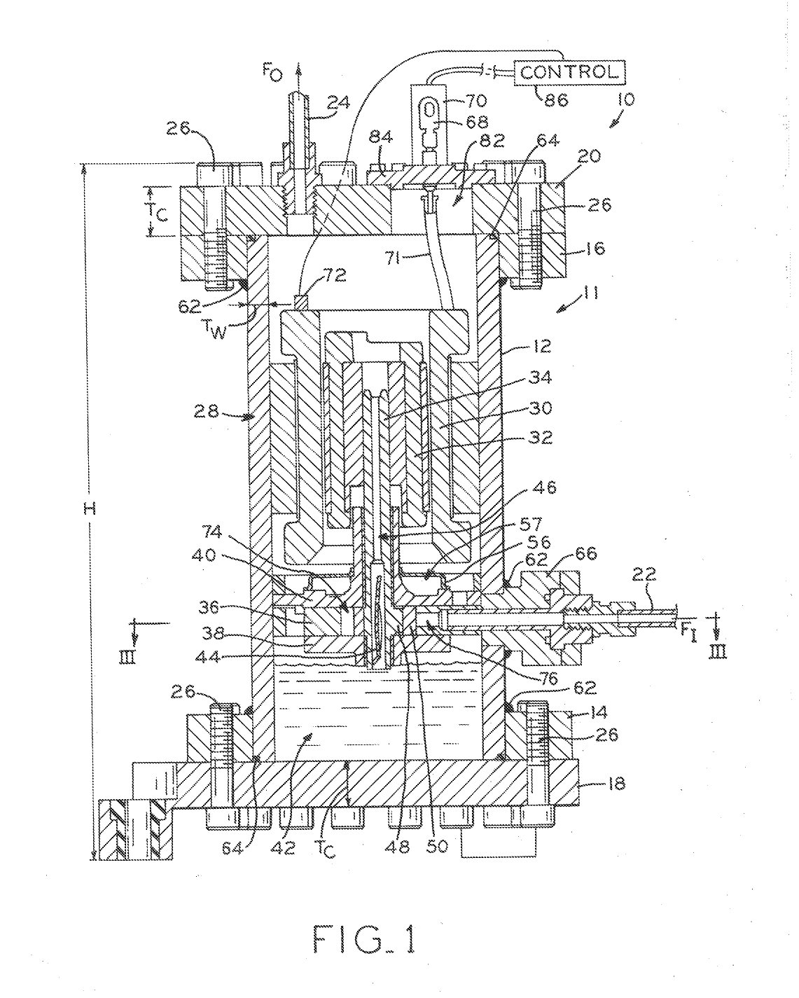

The present disclosure provides compact rotary compressor 10 (FIG. 1), which as described below is designed to handle high pressures and unique requirements associated with, e.g., compression of natural gas (NG) to compressed natural gas (CNG). Advantageously, rotary compressors tend to have a high reliability due to the use of fewer moving parts than other compressor types, such as reciprocating piston compressors, screw compressors, and scroll compressors. Rotary compressors also have a favorable ratio of capacity vs. the physical size of the compressor, and have substantially round/cylindrical housing shapes which are amenable to use in high pressure applications. As described in further detail below, compressor 10 includes reinforced housing 11 adapted to withstand pressures up to and in excess of 3600 psi (24.8 MPa) with minimized risk of leakage or rupture. Compressor 10 further includes an overload protector 72 adjacent to the compressor motor which cooperates with control 86 to ensure that a safe operating temperature, electrical current and operating pressure are maintained within compressor 10 at all times during operation. In addition, electrical connector 68 is provided to facilitate the use of compressor 10 with standard electrical infrastructure, thereby enabling the safe use of compressor 10 for CNG in a variety of service locations, including commercial applications (e.g., vehicle filling stations) and residential use.

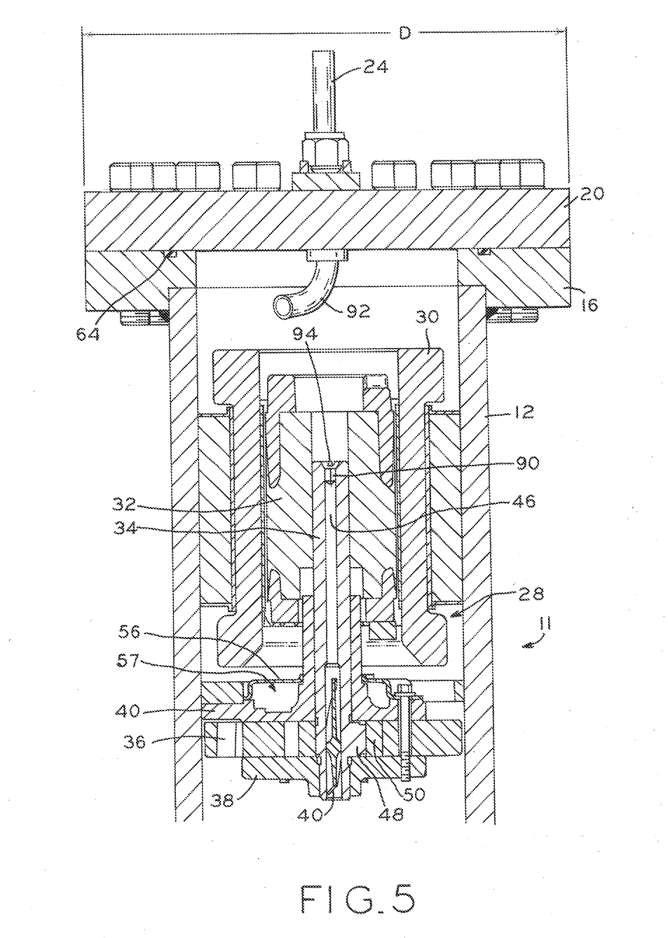

These high-pressure enhancements to the structure and function of compressor 10 are accomplished while maintaining a small overall compressor size, such as about 12 inches (30.5 centimeters) tall and about 6.7 inches (17 centimeters) in diameter. In one embodiment, compressor 10 may define an overall height H (FIG. 1) of as little as 12 inches (30.5 centimeters), 13 inches (33 centimeters) or 15 inches (38.1 centimeters), and as much as 16 inches (40.6 centimeters), 18 inches (45.7 centimeters) or 20 inches (50.8 centimeters), or may define any height H within any range defined by any of the foregoing values. Compressor 10 may also define an overall diameter D (FIG. 5) of as little as 7 inches (17.8 centimeters), 8 inches (20.3 centimeters) or 9 inches (22.9 centimeters) and as large as 10 inches (25.4 centimeters), 12 inches (30.5 centimeters) or 15 inches (38.1 centimeters), or may define any diameter D within any range defined by any of the foregoing values.

Stated another way, the total internal volume within the cavity defined by housing 11 can be defined as V=π*((D−2)/2)²*(H−2), where V is the internal volume expressed in cubic inches and the internal volume is a function of diameter D less 2 inches (5.1 centimeters) to account for 1-inch (2.5-centimeter) thick walls as noted below, and height H less 2 inches (5.1 centimeters) to account for two 1-inch (2.5-centimeter) thick end caps 18, 20, also noted below. By this definition, internal volume V enclosed by housing 11 of compressor 10 is as little as about 196 cubic inches (3,218 cubic centimeters), 311 cubic inches (5,097 cubic centimeters) or 500 cubic inches (8,198 cubic centimeters) and as large as about 704 cubic inches (11,532 cubic centimeters), 1,257 cubic inches (20,593 cubic centimeters) or 2,389 cubic inches (39,152 cubic centimeters), or may be any volume within any range defined by any of the foregoing values.

1. Compressor Construction and Function

Turning to FIG. 1, rotary compressor 10 includes housing 11 containing motor 28 which drives rotation of drive shaft 34 and thereby compresses incoming gas to an elevated pressure and reduced volume, as further described below.

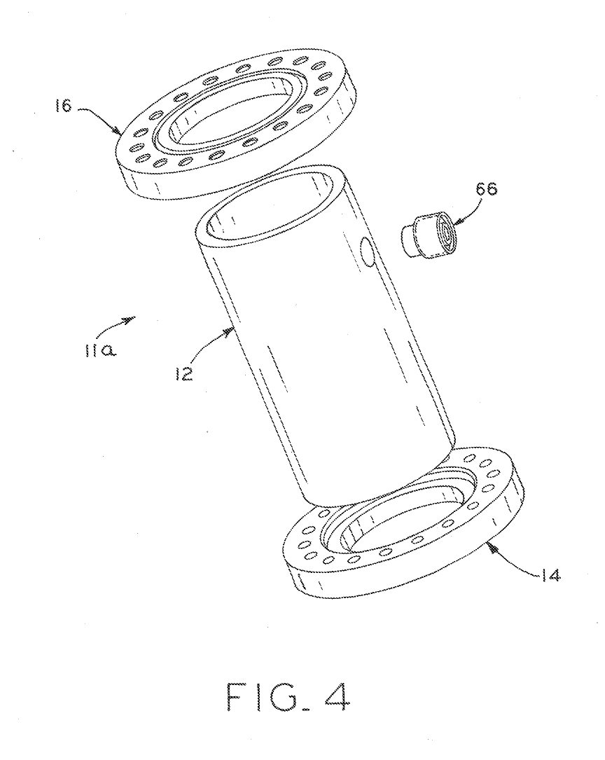

Housing 11 includes an integral base structure 11a (FIG. 4) including cylindrical shell 12 with lower flange 14 fixed to a lower end thereof, and upper flange 16 affixed to an upper end thereof. Lower and upper flanges 14, 16 are ring-shaped structures which extend around the entire periphery of the lower and upper axial ends of shell 12 and are integral with shell 12 as described in further detail below. Housing 11 further includes lower end cap 18 abutting the lower axial end of base structure 11a, and is affixed to lower flange 14 by a series of annularly arranged bolts 26. Similarly, upper end cap 20 abuts the upper axial end of base structure 11a and is affixed to upper flange 16 via another series of annularly arranged bolts 26.

Shell 12, lower and upper flanges 14, 16 and lower and upper end caps 18, 20 all cooperate to form a hermetically sealed enclosure within the cylindrical inner cavity of housing 11. In order to ensure that this hermetically sealed enclosure is completely free of leaks during compressor operation, compressible gaskets 64 may be provided at the interface between the lower and upper axial ends of base structure 11a and lower and upper end caps 18 and 20, respectively. In addition, lower and upper flanges 14, 16 are sealingly (and securely) affixed to shell 12 via weld beads 62, as further described below.

Although housing 11 is hermetically sealed, housing 11 is of course designed to selectively admit working fluid via inlet 22 along inlet fluid direction F_{I}, and to expel the working fluid after compression via outlet 24 along outlet fluid direction F_{O}. In the illustrated exemplary embodiment, inlet 22 is a tube sealingly connected to inlet port 66, which is sealingly fixed, and integral with, shell 12 (e.g., via another weld bead 62). Compressor 10 is shown as a “high side” arrangement in which inlet 22 is disposed near a lower end of housing 11 and outlet 24 is disposed at a top end thereof, and the motor 28 is disposed within the portion of housing 11 which, during use, is at an elevated discharge pressure. Advantageously, a “high side” configuration allows a comparatively smaller required displacement and overall compressor size as compared to a “low side” configuration. Aside from the controlled supply of working fluid via inlet 22 and an associated discharge of the compressed working fluid via outlet 24, the hermetically sealed configuration of housing 11 ensures that no other fluid is allowed to enter or exit housing 11.

Electric motor 28 is contained within shell 12, and includes a stationary stator 30, and rotor 32 rotatably suspended within stator 30 (e.g., by bearings). Motor 28 is configured as a traditional electric motor, in that an application of electrical current to the coils of stator 30 (via electrical cable 71 as further described below) creates an electrical field which causes rotation of rotor 32.

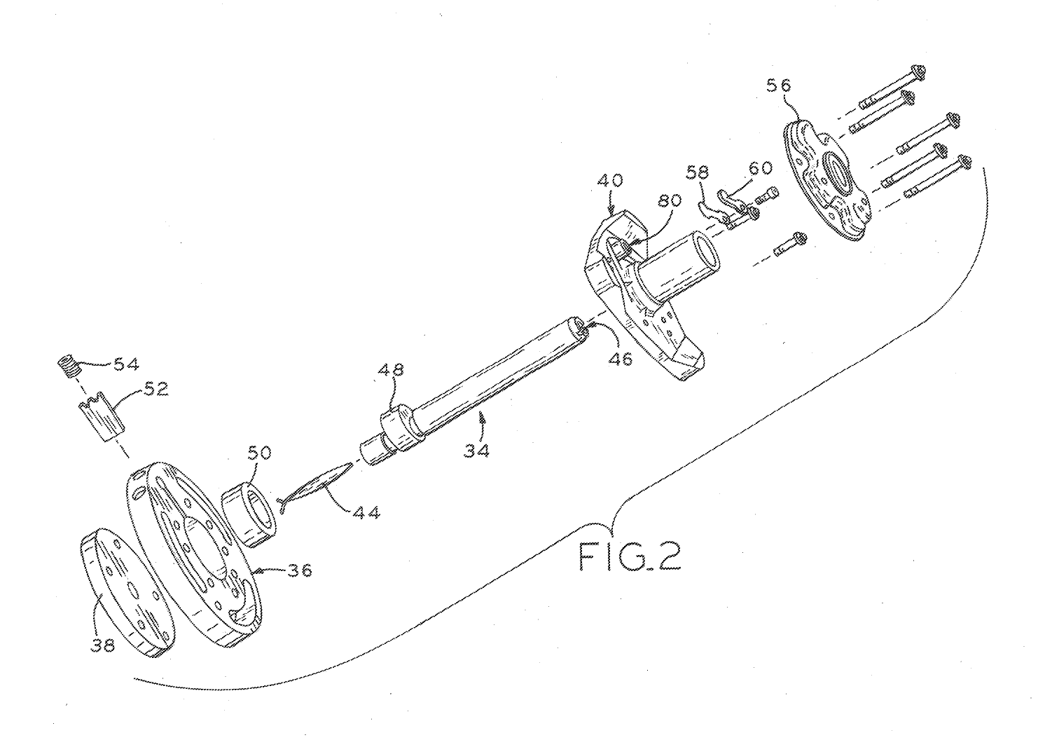

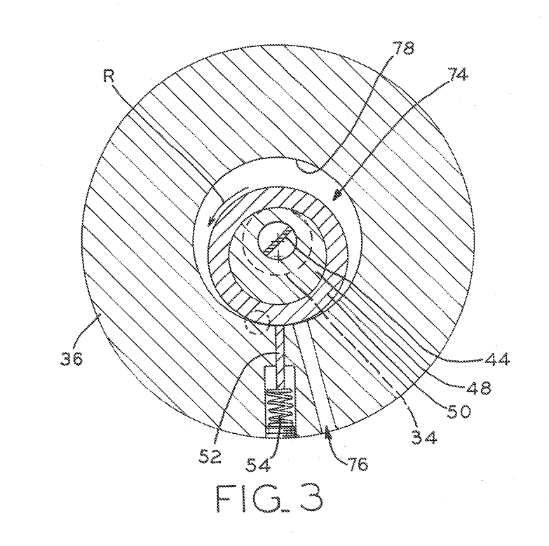

Rotor 32 is affixed to drive shaft 34, which transmits the rotary motive force from rotor 32 to the compression mechanism which operates to compress the working fluid from its inlet flow F_{I} to its outlet flow F_{O}. More particularly and as best seen in FIG. 2, drive shaft 34 is rotatably connected to roller bearing 50 via eccentric portion 48 located at a distal portion of drive shaft 34. As drive shaft 34 rotates under the power of motor 28, roller bearing 50 is eccentrically rotated within central bore 78 formed in cylinder block 36, as best seen in FIG. 3. As this rotation occurs (counterclockwise as illustrated in FIG. 3), a moving contact point between bearing 50 and bore 78 moves around the periphery of bore 78, continuously reconfiguring the orientation of the crescent-shaped compression cavity 74.

Vane 52 is spring-biased into contact with the outer surface of bearing 50 by spring 54, such that vane 52 extends and retracts to maintain such contact regardless of the rotational position of eccentric portion 48 and bearing 50. When the contact point between bearing 50 and bore 78 is coincident with the contact point between bearing 50 and vane 52, as shown in FIG. 3, the compression cycle is ready to begin. Counterclockwise rotation along direction R causes the portion of compression cavity 74 between the bearing/bore contact point and the bearing/vane contact point to begin to shrink in volume. As rotation continues, the bearing/bore contact point continues its path around the periphery of bore 78 to approach the bearing/vane contact point, further reducing the volume of cavity 74 and compressing the gas contained therein. Eventually, the pressure of the gas reaches a threshold level at which flapper valve 58 (FIG. 2) is activated to allow the high-pressure working fluid to escape compression cavity 74 and pass into the upper portion of the cavity within housing 11.

As the volume of cavity 74 steadily decreases as described above to pressurize the gas contained therein, new unpressurized gas is drawn into the opposite, newly expanding cavity 74 via passage 76. Passage 76 is in fluid communication with inlet 22, as best seen in FIG. 2. Thus, when the rotational cycle begins again after exhausting gas upwardly via flapper valve 58, the newly formed cavity 74 is populated with a fresh charge of unpressurized gas from inlet 22 that is ready to be pressurized and exhausted upwardly.

Continuous rotation of drive shaft 34 causes successive intake, pressurization and expulsion of working fluid into the upper portion of housing 11 as described above, thereby elevating the pressure at outlet 24 as compared to inlet 22. This pressurized working fluid is allowed to selectively exit outlet 24.

Cavity 74 is bounded at its axial ends by lower or outboard bearing 38 and upper bearing 40, respectively. Flapper valve 58 selectively permits or prevents fluid flow through discharge outlet 80 formed through upper bearing 40, and is normally biased into a seated, fluid-flow-prevention position against discharge outlet 80 (FIG. 2). The amount of pressure needed to dislodge flapper valve 58 from its seated position is directly correlated to the amount of biasing force provided by valve 58. Valve stop 60 is provided to limit the travel of valve 58 upon opening under pressure.

Each charge of compressed fluid allowed to pass through outlet 80 is received within muffler cavity 57 (FIG. 1), which is defined by muffler 56 (FIGS. 1 and 2) at an upper end and an upper surface of upper bearing 40 at the lower end. This cavity provides an intermediate space for the pressurized gas charge to be received, before passing through apertures in muffler 56 to the main upper portion or discharge chamber of the hermetically sealed interior of housing 11.

The lower portion of the hermetically sealed interior of housing 11 includes oil sump 42, as shown in FIG. 1. Oil is present in oil sump 42 and in fluid communication with the lower axial end of drive shaft 34, as illustrated, such that oil may be drawn upwardly into bore 46 of shaft 34 by oil paddle 44 as shaft rotates. For CNG applications, the oil contained in sump 42 may be a CNG-compatible product. For example, exemplary oil may be polyvinylether oil. Oil paddle 44 drives oil upwardly through bore 46 and to the axial upper end of drive shaft 34, where oil is discharged and flows over the components of motor 28, effecting continuous lubrication of the same during operation of motor 28. In addition, drive shaft 34 may have radial holes (not shown) formed at intervals along its axial length to allow oil to flow radially outwardly to bearing contact points within motor 28 and lower and upper bearings 38, 40.

As noted above, motor 28 receives electrical power via cable 71, which is electrically connected at opposite ends to stator 30 within housing 11 and to electrical connector 68 outside housing 11. In order to facilitate access to cable 71 without disrupting the hermetically sealed configuration of housing 11, upper end cap 20 may have electrical bore 82 formed therein, selectively sealingly capped by bore cover 84 as shown in FIG. 1. Electrical connector 68 may in turn be connected to controller 86 via electrical plug 70. Controller 86 is adapted to issue commands to energize or de-energize stator 30, thereby selectively activating or de-activating motor 28.

2. High-Pressure CNG Functionality

Selected component specifications and arrangements of compressor 10 are uniquely suitable for use in compressing natural gas (NG) at low pressure, e.g., 0.5 psi (0.0035 MPa), into compressed natural gas (CNG) at high pressure, e.g., 2,900-3,600 psi (20-25 MPa). That is, compressor 10 may be used with NG as a working fluid, introduced at inlet 22, compressed, and exhausted at outlet 24, while ensuring safe operation in view of the working fluid's flammability and the high pressures involved with CNG production.

Housing 11 is specifically adapted to handle the high pressure of the present application of rotary compressor 10. Cylindrical shell 12 defines wall thickness T_{W}, which may be at least 1 inch (2.5 centimeters) in thickness. Similarly, bottom and top end caps 18, 20 each define cap thickness T_{C}, which may be at least 1 inch (2.5 centimeters) in thickness. The cross-sectional size and shape of lower and upper flanges 14, 16, and the location of bolts 26 relative to shell 12, also ensures that all materials maintain at least the thickness of shell 12, i.e., thickness T_{W}, throughout. In this exemplary embodiment, shell 12, lower and upper flanges 14, 16 and lower and upper end caps 18, 20 are all made from steel.

In addition, base structure 11 a of housing 11 is formed a single, unitary welded structure as noted above. The components of base structure 11a are shown in the exploded view of FIG. 5, and include shell 12, lower and upper flanges 14, 16, and inlet port 66. Upon assembly, weld beads 62 (FIG. 1) are used to permanently and securely affix shell 12 to lower and upper flanges 14, 16, and to permanently and securely affix inlet port 66 to shell 12. These welds are continuously made around the entire periphery of shell 12 and inlet port 66, respectively, such that very high pressures within housing 11 during compressor operation will not separate the respective parts of base structure 11a. Although the weldment of FIG. 5 is an efficient and cost-effective way to construct base structure 11a, it is contemplated that a solid piece of material could also be created to include a monolithic structure with the respective functions of shell 12, flanges 14, 16 and inlet port 66. Such a monolithic structure could be cast from molten metal, for example, or machined from a metal tube or billet. For purposes of the present disclosure, both monolithic and welded housing structures can be considered to be “unitary” structures, in that the portions of metal material providing attachment points for end caps 18, 20 and inlet 22 are functionally inseparable from one another without destruction of the structure itself.

Bottom and top end caps 18, 20 are attached to lower and upper flanges 14, 16 respectively by a series of evenly spaced bolts, such as eighteen bolts 26 evenly spaced from one another around the periphery of flanges 14, 16 and end caps 18, 20 respectively. These bolts may be of a size and grade sufficient to exceed the necessary tensile strength needed to maintain caps 18, 20 in position with a sufficient margin of safety when housing 11 contains the high pressures associated with CNG production. For example, bolts 26 may be ½-13 grade 8 bolts, or a metric equivalent. In this exemplary embodiment, housing 11 forms a hermetically sealed pressure vessel capable of containing up to 7,000 psi (48.3 MPa) safely, which represents a suitable margin of safety above the 3,600 psi (24.8 MPa) requirement for typical CNG production applications.

Compressor 10 further includes overload protector 72, which is disposed adjacent to stator 30 and measures the temperature of motor 28, the pressure within housing 11 and the current passing through cable 71. If any of these parameters exceed a predetermined safe limit, overload protector 72 sends a signal to controller 86 to deactivate motor 28. Typically, with rotary compressors in standard HVAC/R applications, the overload/protective device is external to the compressor and maintained on the outside of the housing. By contrast, in compressor 10 designed for a CNG application, the overload protector 72 may be placed within the cavity of housing 11 and in direct thermal communication with the windings of stator 30. This location provides more precise monitoring of the conditions to which the working fluid is exposed, such as working fluid pressure, and therefore provides safer operation and enhanced protection of the motor 28.

In use, compressor 10 may be utilized for each of several NG compression stages, with each intermediate stage elevating the pressure from the immediately earlier stage. In this way, compressor 10 can be sized much smaller than other systems which attempt to compress NG into CNG in one stage, or in which a larger compression differential is used between a reduced number of intermediate stages. Overall, compressor 10 can compress NG to CNG of a given pressure while using less power than a single-stage or reduced intermediate-stage system. In an exemplary embodiment, compressor 10 can be adapted to use line power available in most North American homes and businesses, such as 110 VAC or 220 VAC power. Connector 68 may be sized and specified appropriately for this line power functionality.

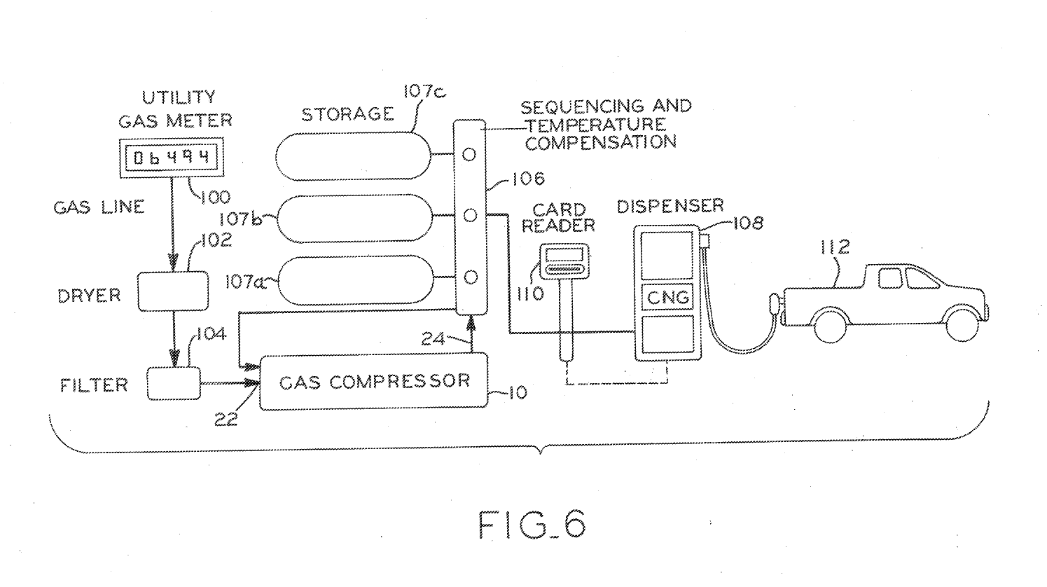

In order to facilitate this multi-stage functionality, a series of valves and holding tanks 107a-107c may be used to selectively use compressor 10 to compress NG between each neighboring pair of compression stages, as illustrated in FIG. 6. Each holding tank 107a-107c contains NG at an elevated pressure, with upstream holding tank 107a having the lowest pressure and downstream holding tank 107c having the highest pressure. Although three tanks 107a, 107b and 107c are shown for illustration purposes, it is contemplated that one tank is provided for each compression stage as required or desired for a particular application.

Compressor 10 first receive atmospheric NG at inlet 22, compresses the atmospheric NG to a first intermediate pressure, and discharges the compressed NG to the upstream holding tank 107a via outlet 24. Valving system or manifold 106 may then reconfigure the system input and output such that inlet 22 receives NG at the first intermediate pressure from upstream holding tank 107a, compresses the NG to a second, higher intermediate pressure, and discharges the higher-pressure NG to second downstream holding tank 107b via outlet 24. This process may be repeated iteratively for any number of stages until CNG at the desired pressure is obtained in a final downstream holding tank 107c.

Referring to FIG. 5, to facilitate oil management within housing 11 of compressor 10 and to minimize the potential for oil to become entrained within the discharged CNG exiting the compressor, compressor includes oil plug 90 fitted into the upper end of drive shaft 34, as well as an angled discharge tube 92. Oil plug 90 closes the upper end of bore 46 in drive shaft 34, and has a small bore 94 to allow gas passage as needed, but which is small enough to minimize passage of oil which is pumped upwardly by oil paddle 44 through bore 46 of drive shaft 34. In one embodiment, bore 94 has a diameter of 0.034±0.005 inches (0.086±0.013 centimeters). Discharge tube 92 is bent to define a curved shape, and has an intake oriented contrary to the gas flow within housing 11 of compressor 10. The orientation ensures that gas is driven through tube 92 toward outlet 24 by the pressure differential between the interior of housing 11 and outlet 24 (and specifically, between the discharge side of motor 28 and the intake of tube 92), rather than by the inertia of gas flow into the intake opening of tube 92 within housing 11. In this way, tube 92 provides preferential gas routing by requiring a change of gas flow direction within housing 11 prior to passage to outlet 24. This arrangement reduces the potential for any compressor oil that may become entrained within the CNG to passing through tube 92, as the entrained oil will tend to precipitate out of the CNG during the change of direction. In this way, the provision and orientation of bend tube 92 eliminates or minimizes the potential for discharge of entrained oil from compressor 10.

With the above structures and functions, compressor 10 can easily handle the 3,600 psi (24.8 MPa) pressures needed for many commercial CNG applications. Moreover, the exemplary embodiment of compressor 10 illustrated in the figures and described in detail above can achieve output pressures at outlet 24 of up to 7,000 psi (48.3 MPa). This can be achieved with overall dimensions of 12 inches (30.5 centimeters) tall and 6.7 inches (17 centimeters) in diameter. This small size facilitates the use of certain industry standard components for compressor 10, which minimizes cost and facilitates repairs. For example, the rotary mechanism, motor, electrical overload protector, and oil used may be industry standard components.

3. Fueling Station Application

Turning now to FIG. 6, one exemplary application for compressor 10 is illustrated schematically. In this application, natural gas (NG) is compressed at a delivery site, such a home or commercial fueling station, to a vehicle 112 adapted to run on compressed natural gas (CNG).

Natural gas service arrives via existing commercial infrastructure, of the type normally delivered to houses and businesses via a metered delivery point 100. A gas line is run from delivery point 100 to a gas dryer 102, as needed, to remove excess moisture contained within the incoming low-pressure NG. In addition, a gas filter 104 may be provided to remove impurities. At this point, the cleaned and dried NG is delivered to inlet 22 of compressor 10 and compressed as described in detail below. This compressed gas is sent to manifold 106 via outlet 24, and stored in intermittent and/or final holding/storage tanks 107a-107c as also described above. At least one of the storage tanks, such as final storage tank 107c, contains CNG at a pressure sufficient to fuel vehicle 112, such as 3,600 psi (24.8 MPa) where vehicle 112 is designed to receive CNG at up to 2,900 psi (20 MPa).

CNG is delivered from the final dispensing tank 107c to vehicle 112 via dispenser 108, which utilizes the pressure differential between tank 107c and the storage tank of vehicle 112 to allow CNG to flow into vehicle 112 at a desired rate and to a desired pressure before automatically shutting off. Optionally, card reader 110 may meter the volume of CNG delivered for monitoring and/or payment. Compressor 10 may operate before, during and/or after a fueling operation in order to maintain the desired pressure in tank(s) 107.

While this invention has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A natural gas compressor comprising:
a housing having an inlet and an outlet, said housing including a unitary base structure and a pair of end caps fixed to said base structure, said housing able to contain a pressure of 3,600 psi (24.8 MPa);
said housing enclosing an internal cavity defining an internal volume between about 196 cubic inches (3,218 cubic centimeters) and about 2,389 cubic inches (39,152 cubic centimeters);
a rotary compressor mechanism disposed within said housing and having an electric motor, said rotary compressor mechanism operable to receive low-pressure natural gas at said inlet, compress the low-pressure natural gas to high-pressure compressed natural gas within said housing, and discharge the high-pressure natural gas at said outlet; and
a control system operably connected to said motor and comprising at least one of a temperature sensor mounted to said motor and a current sensor positioned to measure electrical current supplied to said motor,
said control system configured to deactivate said motor when a predetermined compressor state is detected, said predetermined compressor state comprising at least one of a temperature above a temperature threshold as measured by said temperature sensor and a current above a current threshold as measured by said current sensor.

2. The natural gas compressor of claim 1, further comprising a bent tube disposed between a discharge side of said compressor mechanism and said outlet, said bent tube having an intake oriented away from a gas flow path within said housing.

3. The natural gas compressor of claim 2, further comprising:
an oil sump disposed within said housing;
a drive shaft operably connected to said motor, said drive shaft including a bore in fluid communication with said oil sump;
an oil plug disposed within said bore adjacent to said discharge side of said compressor mechanism, said oil plug including a bore small enough to minimize passage of oil pumped upwardly through said bore of said drive shaft and large enough to allow passage of gas therethrough.

4. The natural gas compressor of claim 1, wherein said housing defines an overall diameter between 7 inches (17.8 centimeters) and 15 inches (38.1 centimeters) and a height between 12 inches (30.5 centimeters) and 20 inches (50.8 centimeters).

5. The natural gas compressor of claim 1, wherein:
said unitary base structure is made of steel and defining a minimum material thickness of one inch (2.5 centimeters);
a top one of said pair of end caps is made of steel and defining a minimum material thickness of one inch (2.5 centimeters), said top end cap sealingly attached to a first open end of said unitary base structure;
a bottom one of said pair of end caps is made of steel and defining a minimum material thickness of one inch (2.5 centimeters), said bottom end cap sealingly attached to a second open end of said unitary base structure such that said unitary base structure, such that said top end cap and said bottom end cap define a hermetically sealed housing.

6. The natural gas compressor of claim 5, wherein said unitary base structure comprises:
a cylindrical shell;
a lower flange welded to a lower end of said cylindrical shell, said bottom end cap affixed to said lower flange by bolts; and
an upper flange welded to an upper end of said cylindrical shell, said top end cap affixed to said upper flange by bolts.

7. The natural gas compressor of claim 6, further comprising an inlet port welded to said cylindrical shell at said inlet.

8. The natural gas compressor of claim 1, in combination with a natural gas compression system comprising:
a natural gas supply;
a plurality of storage tanks adapted to receive and store said natural gas at an elevated pressure, said plurality of storage tanks including an upstream tank having a first pressure and a downstream tank having a second pressure higher than the first pressure;
a valving arrangement operably coupled to said natural gas compressor, said plurality of storage tanks and said natural gas supply,
said valving arrangement having a first-stage configuration in which said compressor mechanism receives natural gas from said natural gas supply via said inlet, compresses the natural gas, and transmits the natural gas via said outlet to said upstream tank,
said valving arrangement having a second-stage configuration in which said compressor mechanism receives natural gas from said upstream tank, further compresses the natural gas, and transmits the natural gas via said outlet to said downstream tank.

9. A natural gas compressor comprising:
a housing comprising:
a unitary base structure made of steel and defining a minimum material thickness of one inch (2.5 centimeters);
a top end cap made of steel and defining a minimum material thickness of one inch (2.5 centimeters), said top end cap sealingly attached to a first open end of said unitary base structure;
a bottom end cap made of steel and defining a minimum material thickness of one inch (2.5 centimeters), said bottom end cap sealingly attached to a second open end of said unitary base structure such that said unitary base structure, said top end cap and said bottom end cap define a hermetically sealed cavity having an inlet and an outlet;
said housing defining an overall diameter between 7 inches (17.8 centimeters) and 15 inches (38.1 centimeters) and a height between 12 inches (30.5 centimeters) and 20 inches (50.8 centimeters);
a compressor mechanism disposed within said housing and including a compressor motor, said compressor mechanism operable to receive low-pressure natural gas at said inlet, compress the low-pressure natural gas to high-pressure compressed natural gas within said housing, and discharge the high-pressure natural gas at said outlet; and
a control system operably connected to said compressor mechanism and comprising at least one of a temperature sensor mounted to said motor and a current sensor positioned to measure electrical current supplied to said motor,
said control system configured to deactivate said motor when a predetermined compressor state is detected, said predetermined compressor state comprising at least one of a temperature above a temperature threshold as measured by said temperature sensor and a current above a current threshold as measured by said current sensor.

10. The natural gas compressor of claim 9, wherein said compressor mechanism comprises a rotary compressor.

11. The natural gas compressor of claim 9, further comprising a bent tube disposed between a discharge side of said compressor mechanism and said outlet, said bent tube having an intake oriented away from a gas flow path within said housing.

12. The natural gas compressor of claim 9, wherein said unitary base structure comprises:
a cylindrical shell;
a lower flange welded to a lower end of said cylindrical shell, said bottom end cap affixed to said lower flange by bolts; and
an upper flange welded to an upper end of said cylindrical shell, said top end cap affixed to said upper flange by bolts.

13. The natural gas compressor of claim 12, further comprising an inlet port welded to said cylindrical shell at said inlet.

14. The natural gas compressor of claim 1, in combination with a natural gas compression system comprising:
a natural gas supply;
a plurality of storage tanks adapted to receive and store said natural gas at an elevated pressure, said plurality of storage tanks including an upstream tank having a first pressure and a downstream tank having a second pressure higher than the first pressure;
a valving arrangement operably coupled to said natural gas compressor, said plurality of storage tanks and said natural gas supply,
said valving arrangement having a first-stage configuration in which said compressor mechanism receives natural gas from said natural gas supply via said inlet, compresses the natural gas, and transmits the natural gas via said outlet to said upstream tank,
said valving arrangement having a second-stage configuration in which said compressor mechanism receives natural gas from said upstream tank, further compresses the natural gas, and transmits the natural gas via said outlet to said downstream tank.

15. A multistage natural gas compression system comprising:
a natural gas supply;
a plurality of storage tanks adapted to receive and store said natural gas at an elevated pressure, said plurality of storage tanks including an upstream tank having a first pressure and a downstream tank having a second pressure higher than the first pressure;
a compact natural gas compressor comprising:
a hermetically sealed housing having a fluid inlet and a fluid outlet, said fluid inlet in selective fluid communication with said natural gas supply and at least one of said plurality of storage tanks, said fluid outlet in selective fluid communication with each of said plurality of storage tanks,
said housing enclosing an internal cavity defining an internal volume between about 196 cubic inches (3,218 cubic centimeters) and about 2,389 cubic inches (39,152 cubic centimeters); and
a compressor mechanism including a motor disposed within said housing between said fluid inlet and said fluid outlet,
a valving arrangement operably coupled to said compressor, said plurality of storage tanks and said natural gas supply,
said valving arrangement having a first-stage configuration in which said compressor mechanism receives natural gas from said natural gas supply via said inlet, compresses the natural gas, and transmits the natural gas via said fluid outlet to said upstream tank,
said valving arrangement having a second-stage configuration in which said compressor mechanism receives natural gas from said upstream tank, further compresses the natural gas, and transmits the natural gas via said fluid outlet to said downstream tank.

16. The multistage natural gas compression system of claim 15, wherein said compressor mechanism comprises a rotary compressor.

17. The multistage natural gas compression system of claim 15, further comprising a control system operably connected to said motor and comprising at least one of a temperature sensor mounted to said motor, a current sensor positioned to measure electrical current supplied to said motor, and a pressure sensor disposed within said housing adjacent said fluid outlet,
said control system configured to deactivate said motor when a predetermined compressor state is detected, said predetermined compressor state comprising at least one of a temperature above a temperature threshold as measured by said temperature sensor, a current above a current threshold as measured by said current sensor, and a pressure above a pressure threshold as measured by said pressure sensor.

18. The multistage natural gas compression system of claim 15, further comprising a bent tube disposed between a discharge side of said compressor mechanism and said fluid outlet, said bent tube having an intake oriented away from a gas flow path within said housing.

19. The multistage natural gas compression system of claim 15, said housing able to contain a pressure of 3,600 psi (24.8 MPa), said housing comprising:
a unitary base structure made of steel and defining a minimum material thickness of one inch (2.5 centimeters);
a top end cap made of steel and defining a minimum material thickness of one inch (2.5 centimeters), said top end cap sealingly attached to a first open end of said unitary base structure;
a bottom end cap made of steel and defining a minimum material thickness of one inch (2.5 centimeters), said bottom end cap sealingly attached to a second open end of said unitary base structure such that said unitary base structure, said top end cap and said bottom end cap define a hermetically sealed cavity.

20. The multistage natural gas compression system of claim 19, wherein said unitary base structure comprises:
a cylindrical shell;
a lower flange welded to a lower end of said cylindrical shell, said bottom end cap affixed to said lower flange by bolts; and
an upper flange welded to an upper end of said cylindrical shell, said top end cap affixed to said upper flange by bolts.
